(19) United States
(12) Patent Application Publication
(10) Pub. No.: US 2016/0260041 A1
(43) Pub. Date: Sep. 8, 2016

(54) SYSTEM AND METHOD FOR MANAGING WEB-BASED REFINERY PERFORMANCE OPTIMIZATION USING SECURE CLOUD COMPUTING

(71) Applicant: UOP LLC, Des Plaines, IL (US)

(72) Inventors: Ian G. Horn, Streamwood, IL (US); Christophe Romatier, Wilmette, IL (US); Paul Kowalczyk, Hoffman Estates, IL (US); Zak Alzein, Burr Ridge, IL (US)

(21) Appl. No.: 15/058,658

(22) Filed: Mar. 2, 2016

Related U.S. Application Data
(60) Provisional application No. 62/127,642, filed on Mar. 3, 2015.

(51) Int. Cl. G06Q 10/06; G06Q 50/04

(52) U.S. Cl. CPC G06Q 10/06316; G06Q 50/04; G06Q 10/067

(57) ABSTRACT

A management system for improving operation of a plant. A server is coupled to the management system for communicating with the plant via a communication network. A computer system has a web-based platform for receiving and sending plant data related to the operation of the plant over the network. A display device interactively displays the plant data. An optimization unit is configured for optimizing at least a portion of a refining or petrochemical process of the plant by acquiring the plant data from the plant on a recurring basis, analyzing the plant data for completeness, correcting the plant data for an error. The optimization unit corrects the plant data for a measurement issue and an overall mass balance closure, and generates a set of reconciled plant data based on the corrected plant data.

### CROSS-REFERENCE

This application claims priority under 35 U.S.C. §119(e) of U.S. Provisional Application Ser. No. 62/127,642 filed Mar. 3, 2015 which is incorporated herein by reference in its entirety.

### FIELD OF THE INVENTION

The present invention is related to a method and system for managing the operation of a plant, such as a petrochemical plant or a refinery, and more particularly to a method for improving the performance of operations in a plant using a secure cloud computing infrastructure.

### BACKGROUND OF THE INVENTION

Companies operating refineries and petrochemical complexes typically face tough challenges in today's environment. These challenges can include eroding profit margins, increasingly complex technologies, a reduction in workforce experience levels and changing environmental regulations.

As feed and product prices become more volatile, operators often find it more difficult to make the operating decisions that can optimize financial margin. This volatility may be unlikely to ease in the foreseeable future; however, it can represent economic potential to those companies that can quickly identify and respond to market opportunities as they arise.

Pressures from capital markets are generally forcing operating companies to continually increase the return on existing assets. In response, catalyst, adsorbent, equipment, and control system suppliers develop more complex systems that can increase asset performance. Maintenance and operation of these advanced systems generally requires advanced skill levels that can be difficult to develop, maintain, and transfer given the time pressures and limited resources of today's technical personnel. This means that these increasingly complex systems are not always operated to their highest potential. In addition, as existing assets are operated close to and beyond their design limits, reliability concerns and operational risks can increase.

Plant operators typically respond to above challenges with one or more of several strategies, such as, for example, availability risk reduction, working the value chain and continuous economic optimization. Availability risk reduction generally places an emphasis on achieving adequate plant operations as opposed to maximizing economic performance. Working the value chain typically places an emphasis on improving the match of feed and product mix with asset capabilities and market demands. Continuous economic optimization often employs tools, systems and models to continuously monitor and bridge the economic and operational gaps in plant performance.

There are two levels of gaps (or performance deficits) that refinery operators typically experience:

1) Events or “Lost Opportunities” Gap Most refinery operators do a good job of tracking the cost/value of unplanned events in their refineries: unplanned shutdowns, equipment availability problems, etc. The value associated with these gaps is generally large, but the duration is normally short. Well-operated refineries can keep these events to a minimum through effective process and mechanical reliability programs.

2) Backcasting Gap

Some refineries focus on a backcasting (historical) gap. This is typically done on a monthly basis. The operator compares the monthly refinery production plan against the actual achieved operations, and conducts an analysis to understand and resolve the cause(s) for any gap(s). Refinery operators can often uncover substantial economic improvement if they resolve the root causes for deviation from refinery production process plans. However, when root causes are embedded in poor process performance, they are often difficult to identify. This historical analysis also can be costly in that it leaves issues unidentified and un-resolved until the end of the month. As an example only, a 1% debit in octane-barrel production from a 30,000 BPD Naphtha Reforming Process unit can be worth $530,000 over a month (at $0.60/oct-bbl).

Early identification of this gap and resolution of the problems can avoid significant profit losses. There is a need for a method that can enable continuous, consistent levels of desired performance.

Therefore, there is a need for an improved management system for operators to respond to these challenges by utilizing a strategy of economic optimization which employs tools, systems and models to monitor and bridge the economic and operational gaps in plant performance.

### SUMMARY OF THE INVENTION

A general object of the invention is to improve operation efficiency of petrochemical plants and refineries. A more specific object of this invention is to overcome one or more of the problems described above. A general object of this invention can be attained, at least in part, through a method for improving operation of a plant. The method includes obtaining plant operation information from the plant.

The present invention further comprehends a method for improving operation of a plant that includes obtaining plant operation information from the plant and generating a plant process model using the plant operation information. This invention still further comprehends a method for improving operation of a plant. The method includes receiving plant operation information over the internet and automatically generating a plant process model using the plant operation information.

The present invention utilizes configured process models to monitor, predict, and optimize performance of individual process units, operating blocks and/or complete processing systems. Routine and frequent analysis of predicted versus actual performance allows early identification of operational discrepancies which can be acted upon to optimize financial impact.

This method of this invention is preferably implemented using a web-based computer system. The benefits of executing work processes within this platform include improved plant economic performance due to an increased ability by operations to identify and capture economic opportunities, a sustained ability to bridge performance gaps, an increased ability to leverage personnel expertise, and improved enterprise management. The present invention is a new and innovative way of using advanced computing technology in combination with other parameters to change the way plants, such as refineries and petrochemical facilities, are operated.

The present invention uses a data collection system at a plant to capture data which is automatically sent to a remote location, where it is reviewed to, for example, eliminate errors and biases, and used to calculate and report performance results. The performance of the plant and/or individual process units of the plant is/are compared to the performance predicted by one or more process models to identify any operating differences, or gaps.

A report, such as a daily report, showing actual performance compared to predicted performance can be generated and delivered to a plant operator and/or a plant or third party process engineer such as, for example, via the internet. The identified performance gaps allow the operators and/or engineers to identify and resolve the cause of the gaps. The method of this invention further uses the process models and plant operation information to run optimization routines that converge on an optimal plant operation for the given values of, for example, feed, products and prices.

The method of this invention provides plant operators and/or engineers with regular advice that enable recommendations to adjust setpoints allowing the plant to run continuously at or closer to optimal conditions. The method of this invention provides the operator alternatives for improving or modifying the operations of the plant. The method of this invention regularly maintains and tunes the process models to correctly represent the true potential performance of the plant. The method of one embodiment of this invention includes economic optimization routines configured per the operator's specific economic criteria which are used to identify optimum operating points, evaluate alternative operations and do feed evaluations.

The present invention provides a repeatable method that will help refiners bridge the gap between actual and achievable economic performance. The method of this invention utilizes process development history, modeling and stream characterization, and plant automation experience to address the critical issues of ensuring data security and well as efficient aggregation, management and movement of large amounts of data. Web-based optimization is a preferred enabler to achieving and sustaining maximum process performance by connecting, on a virtual basis, technical expertise and the plant process operations staff.

The enhanced workflow utilizes configured process models to monitor, predict, and optimize performance of individual process units, operating blocks, or complete processing systems. Routine and frequent analysis of predicted versus actual performance allows early identification of operational discrepancies which can be acted upon to optimize financial impact.

As used herein, references to a “routine” are to be understood to refer to a sequence of computer programs or instructions for performing a particular task. References herein to a “plant” are to be understood to refer to any of various types of chemical and petrochemical manufacturing or refining facilities. References herein to a plant “operators” are to be understood to refer to and/or include, without limitation, plant planners, managers, engineers, technicians, and others interested in, overseeing, and/or running the daily operations at a plant.

In one embodiment, a management system is provided for improving operation of a plant. A server is coupled to the management system for communicating with the plant via a communication network. A computer system has a web-based platform for receiving and sending plant data related to the operation of the plant over the network. A display device interactively displays the plant data. An optimization unit is configured for optimizing at least a portion of a refining or petrochemical process of the plant by acquiring the plant data from the plant on a recurring basis, analyzing the plant data for completeness, correcting the plant data for an error. The optimization unit corrects the plant data for a measurement issue and an overall mass balance closure, and generates a set of reconciled plant data based on the corrected plant data.

In another embodiment, a management system is provided for improving operation of a plant. A server is coupled to the management system for communicating with the plant via a communication network. A computer system has a web-based platform for receiving and sending plant data related to the operation of the plant over the network. A display device interactively displays the plant data. The display device is configured for graphically or textually receiving an input signal from the management system using a human machine interface via a dedicated communication infrastructure. A visualization unit is configured for creating an interactive display for a user, and displaying the plant data using a visual indicator on the display device based on a hue and color technique, which discriminates a quality of the displayed plant data.

In yet another embodiment, a management method is provided for improving operation of a plant. Included in the method are providing a server coupled to a management system for communicating with the plant via a communication network; providing a computer system having a web-based platform for receiving and sending plant data related to the operation of the plant over the network; providing a display device for interactively displaying the plant data, the display device being configured for graphically or textually receiving an input signal from the management system using a human machine interface via a dedicated communication infrastructure; creating an interactive display for a user, and displaying the plant data using a visual indicator on the display device based on a hue and color technique, which discriminates a quality of the displayed plant data; and generating a plant process model using the plant data for predicting plant performance expected based on the plant data, the plant process model being generated by an iterative process that models based on at least one plant constraint being monitored for the operation of the plant.

The foregoing and other aspects and features of the present invention will become apparent to those of reasonable skill in the art from the following detailed description, as considered in conjunction with the accompanying drawings.

### BRIEF DESCRIPTION OF THE DRAWINGS

FIG. 1 illustrates an exemplary use of the present management system in a cloud computing infrastructure;

FIG. 2 is a functional block diagram of the present management system featuring functional units in accordance with an embodiment of the present disclosure;

FIGS. 2A-2E illustrate exemplary dashboards used in the present management system for displaying hierarchical data in accordance with an embodiment of the present disclosure; and

FIG. 3 illustrates an exemplary management method in accordance with an embodiment of the present management system.

### DETAILED DESCRIPTION OF THE INVENTION

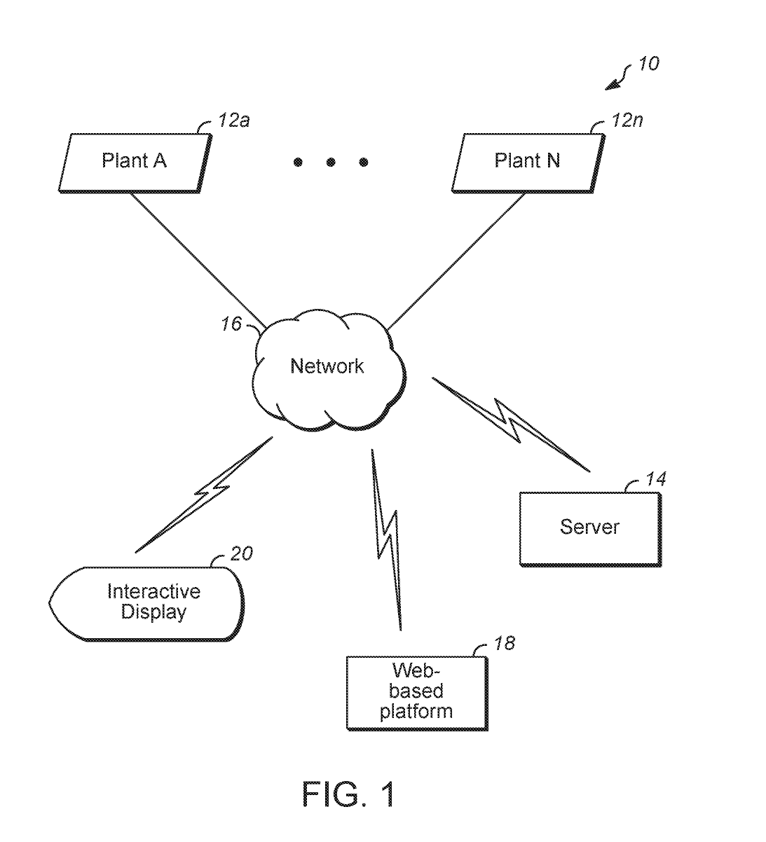

Referring now to FIG. 1, an exemplary management system, generally designated 10, using an embodiment of the present disclosure is provided for improving operation of one or more plants (e.g., Plant A . . . Plant N)12a-12n, such as a chemical plant or refinery, or a portion thereof. The present management system 10 uses plant operation information obtained from at least one plant 12a-12n.

As used herein, the term “system,” “unit” or “module” may refer to, be part of, or include an Application Specific Integrated Circuit (ASIC), an electronic circuit, a computer processor (shared, dedicated, or group) and/or memory (shared, dedicated, or group) that executes one or more software or firmware programs, a combinational logic circuit, and/or other suitable components that provide the described functionality. Thus, while this disclosure includes particular examples and arrangements of the units, the scope of the present system should not be so limited since other modifications will become apparent to the skilled practitioner.

The management system 10 may reside in or be coupled to a server or computing device 14 (including, e.g., database and video servers), and is programmed to perform tasks and display relevant data for different functional units via a communication network 16, preferably using a secured cloud computing infrastructure. It is contemplated that other suitable networks can be used, such as the internet, a wireless network (e.g., Wi-Fi), a corporate Intranet, a local area network (LAN) or a wide area network (WAN), and the like, using dial-in connections, cable modems, high-speed ISDN lines, and other types of communication methods known in the art. All relevant information can be stored in databases for retrieval by the management system 10 or the computing device 14 (e.g., as a data storage device and/or a machine readable data storage medium carrying computer programs).

Further, the present management system 10 can be partially or fully automated. In one preferred embodiment of this invention, the management system 10 is performed by a computer system, such as a third-party computer system, remote from the plant 12a-12n and/or the plant planning center. The present management system 10 preferably includes a web-based platform 18 that obtains or receives and sends information over the internet. Specifically, the management system 10 receives signals and parameters via the communication network 16, and displays preferably in real time related performance information on an interactive display device 20 accessible to an operator or user.

Using a web-based system for implementing the method of this invention provides many benefits, such as improved plant economic performance due to an increased ability by plant operators to identify and capture economic opportunities, a sustained ability to bridge plant performance gaps, and an increased ability to leverage personnel expertise and improve training and development. The method of this invention allows for automated daily evaluation of process performance, thereby increasing the frequency of performance review with less time and effort required from plant operations staff.

The web-based platform 18 allows all users to work with the same information, thereby creating a collaborative environment for sharing best practices or for troubleshooting. The method of this invention provides more accurate prediction and optimization results due to fully configured models which can include, for example, catalytic yield representations, constraints, degrees of freedom, and the like. Routine automated evaluation of plant planning and operation models allows timely plant model tuning to reduce or eliminate gaps between plant models and the actual plant performance. Implementing the method of this invention using the web-based platform 18 also allows for monitoring and updating multiple sites, thereby better enabling facility planners to propose realistic optimal targets.

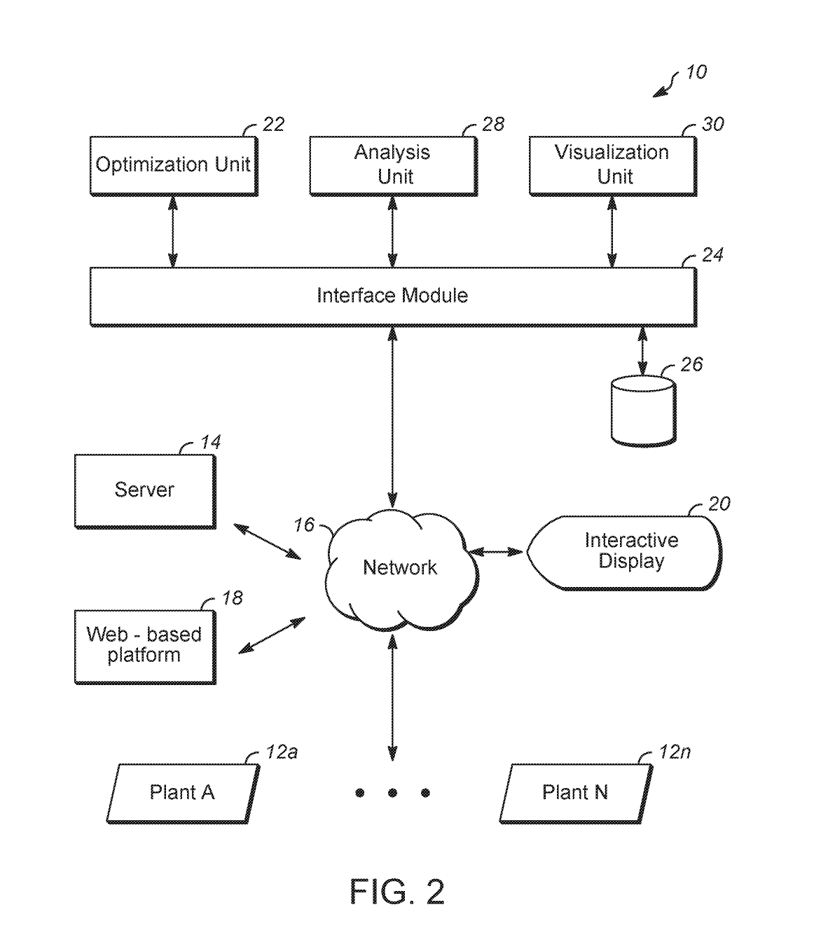

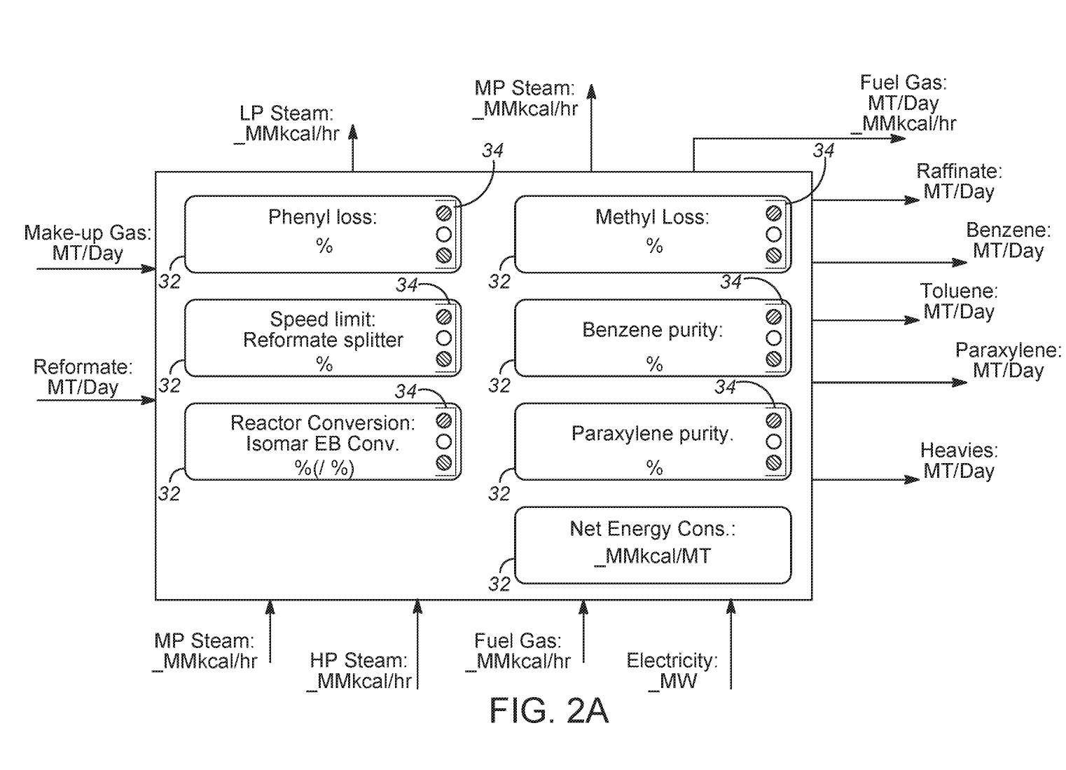

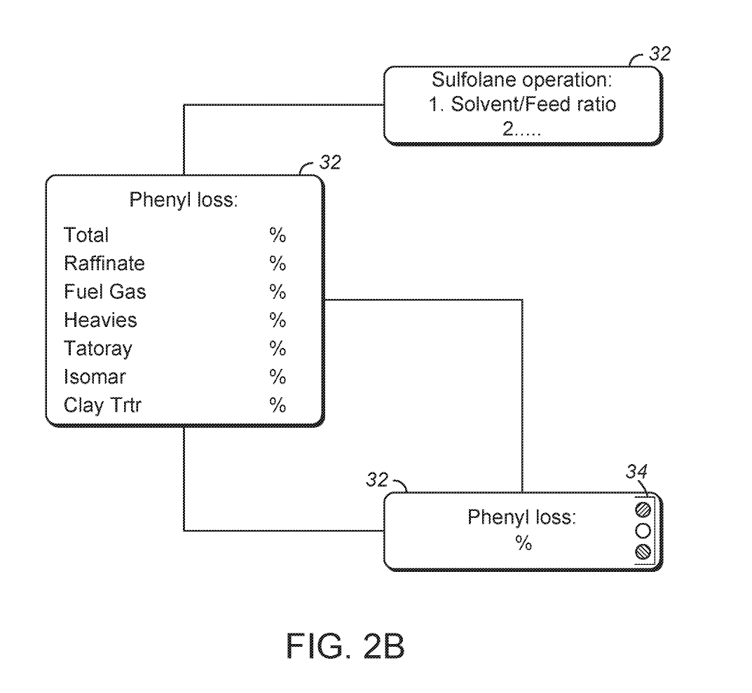

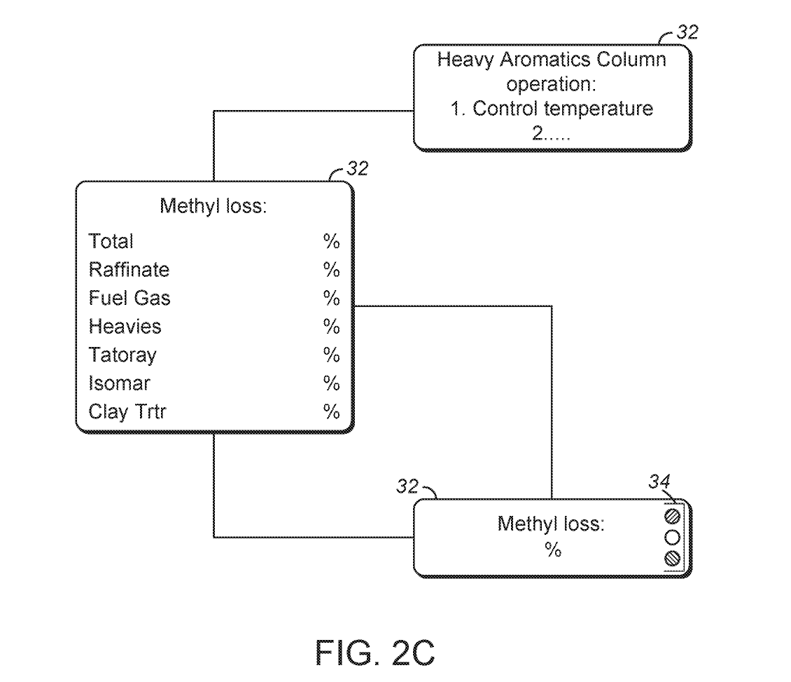

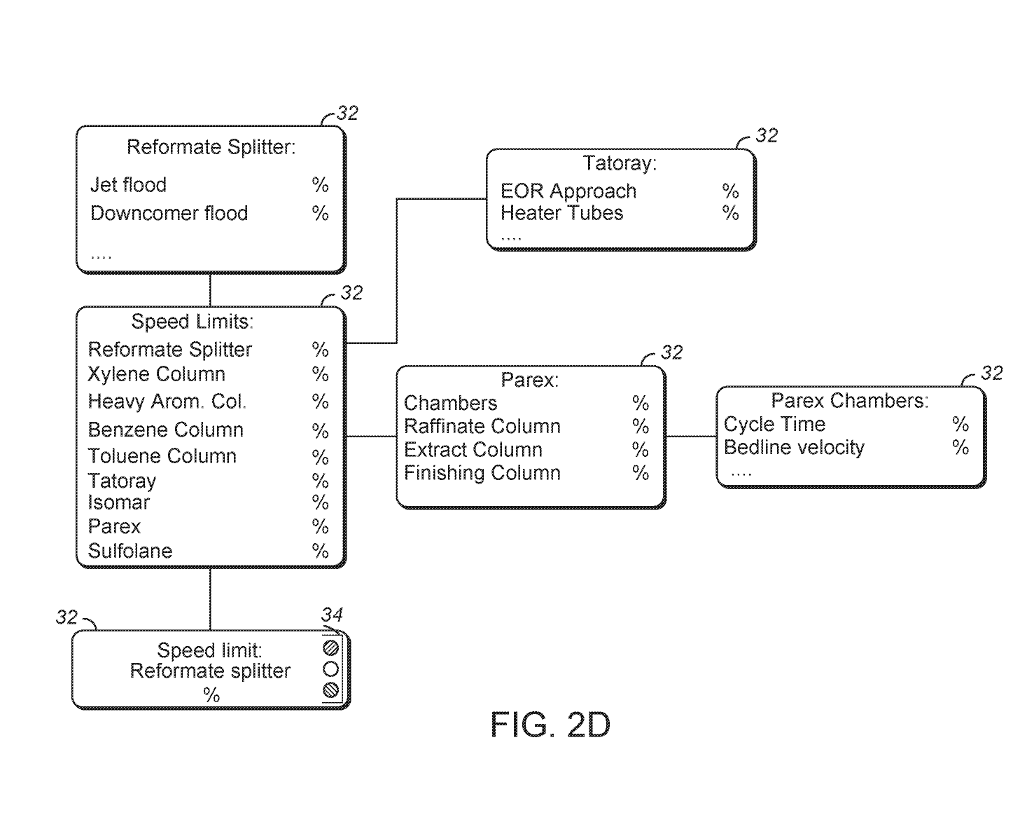

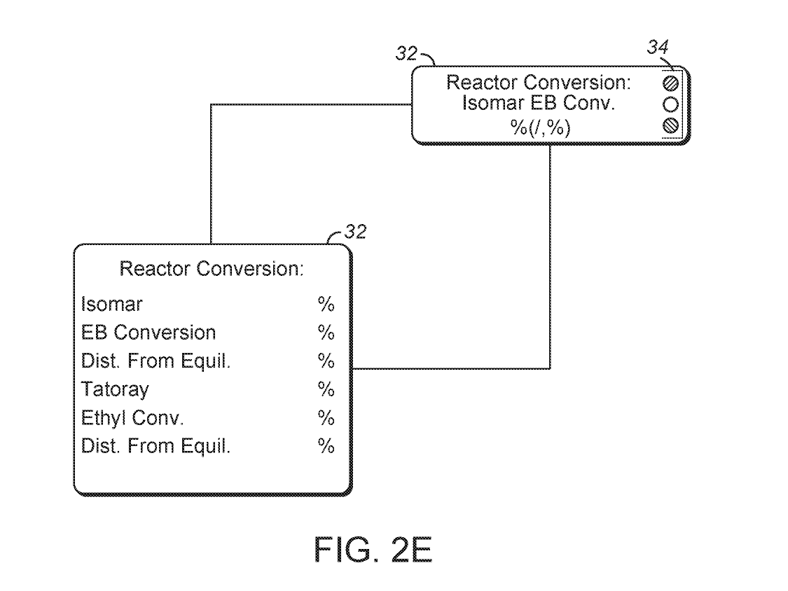

Referring now to FIG. 2, it is preferred that the present management system 10 includes an optimization unit 22 configured for optimizing at least a portion of the refining or petrochemical process of at least one plant 12a-12n. It is difficult for operators in the refining and petrochemical field to optimize the economics at the level of an entire complex of the plant 12a-12n because there are various parameters and measurements that may not provide a cohesive basis for process simulation and optimization.

Also included in the management system 10 is an interface module 24 for providing an interface between the management system 10, one or more internal or external databases 26, and the network 16. The interface module 24 receives data from, for example, plant sensors and parameters via the network 16, and other related system devices, services, and applications. The other devices, services, and applications may include, but are not limited to, one or more software or hardware components, etc., related to the respective plants 12a-12n. The interface module 24 also receives the signals and/or parameters, which are communicated to the respective units and modules, such as the management system 10, and its associated computing modules or units.

For example, the optimization unit 22 acquires data from a customer site or plant 12a-12n on a recurring basis. For cleansing, the data is analyzed for completeness and corrected for gross errors by the optimization unit 22. Then, the data is corrected for measurement issues (e.g., an accuracy problem for establishing a simulation steady state) and overall mass balance closure to generate a duplicate set of reconciled plant data.

The corrected data is used as an input to a simulation process, in which the process model is tuned to ensure that the simulation process matches the reconciled plant data. An output of the reconciled plant data is input into a tuned flowsheet, and then is generated as a predicted data. Each flowsheet may be a collection of virtual process model objects as a unit of process design. A delta value, which is a difference between the reconciled data and the predicted data, is validated to ensure that a viable optimization case is established for a simulation process run.

Next, a tuned simulation engine is used as a basis for the optimization case, which is run with a set of the reconciled data as an input. The outputs from this step is a new set of data, namely an optimized data. A difference between the reconciled data and the optimized data provides an indication as to how the operations should be changed to reach a greater economic optimum. In this configuration, the optimization unit 22 provides a user-configurable method for minimizing objective functions, thereby maximizing production of the plant 12a-12n.

In a preferred embodiment, the optimization unit 22 defines an objective function as a user-defined calculation of total cost of operation during a particular process, including materials consumed, products produced, and utilities utilized, subject to various constraints. For example, a maximum hydraulic limit may be determined by a flooding limit subject to a fractionating column capacity, and a maximum temperature in a furnace may be determined based on a temperature of a furnace tube or heater. Other suitable objective functions are contemplated to suit different applications.

Also included in the present management system 10 is an analysis unit 28 configured for determining an operating status of the refinery or petrochemical plant to ensure robust and profitable operation of the plant 12a-12n. The analysis unit 28 determines the operating status based on at least one of a kinetic model, a parametric model, an analytical tool, and a related knowledge and best practice standard.

In a preferred embodiment, the analysis unit 28 receives historical or current performance data from at least one of the plants 12a-12n to proactively predict future actions to be performed. To predict various limits of a particular process and stay within the acceptable range of limits, the analysis unit 28 determines target operational parameters of a final product based on actual current and/or historical operational parameters, e.g., from a steam flow, a heater, a temperature set point, a pressure signal, and the like.

For example, in using the kinetic model or other detailed calculations, the analysis unit 28 establishes boundaries or thresholds of operating parameters based on existing limits and/or operating conditions. Exemplary existing limits may include mechanical pressures, temperature limits, hydraulic pressure limits, and operating lives of various components. Other suitable limits and conditions are contemplated to suit different applications.

In using the knowledge and best practice standard, such as specific know-hows, the analysis unit 28 establishes relationships between operational parameters related to the specific process. For example, the boundaries on a naphtha reforming reactor inlet temperature may be dependent on a regenerator capacity and hydrogen-to-hydrocarbon ratio, which is itself dependent on a recycle compressor capacity.

It is preferred that the present management system 10 includes a visualization unit 30 configured for displaying plant performance variables using the display device 20. It is contemplated that the visualization unit 30 displays a current state of the plant 12a-12n using a dashboard, grouping related data into one or more display sets based on a source of the data for meaningfully illustrating relationships of the displayed data. In this configuration, the user quickly identifies the information, and effectively gains insightful interpretation presented by the displayed data.

In a preferred embodiment, the management system 10 interfaces with the network 16, and performs the performance analysis of the given plant 12a-12n. The management system 10 manages interactions between the operators and the present system by way of a human machine interface (HMI), such as a keyboard, a touch sensitive pad or screen, a mouse, a trackball, a voice recognition system, and the like.

Preferably, the display device 20 (e.g., textual and graphical) is configured for receiving an input signal from the operators and/or the management system 10. In one embodiment, the operator uses an input device, such as the HMI, to graphically or textually interact with the present system 10. It is contemplated that the HMI is part of the display device 20, and the signals and/or parameters are generally received in the management system 10 and then transferred to the display device 20 via a dedicated communication system, preferably using the cloud computing infrastructure.

Referring now to FIGS. 2A-2E, an exemplary dashboard, using hue and color techniques, is shown to interpolate color indications and other signals for the plant parameters (or plant data). It is contemplated that the visualization unit 30 creates an interactive and visually engaging display for the user or operator. The display device 20 provides adequate attention to the important parameters, and insight into their meanings based on the hue and color techniques. It is also contemplated that other suitable visualization techniques having visual indicators may be used to readily discriminate the quality of displayed data on the display device 20. Specifically, the visualization unit 30 provides a hierarchical structure of detailed explanation on the parameters shown on the display device 20, such that the user can selectively expand or drill down into a particular level of the parameters.

For example, to achieve the drill down navigation, selectively clicking on a display item 32 in the initial screen can start and open up a new display window with more detailed information about the parameter calculation. Further clicking on the corresponding display item 32 generates more information such that the user can obtain the desired specific information as needed.

It is contemplated that the visualization unit 30 displays parameters related to an aromatics complex. FIG. 2A shows an exemplary display window illustrating high-level process effectiveness calculations and energy efficiency parameters of the plant 12 along with important operating limits. The operating limits are adaptive depending on which parameters are the closest to their limits. More specifically, the operating limits are displayed based on at least one of the operational parameters, such as yields and losses, an energy efficiency, operational thresholds or limits, a process efficiency or purity, and the like. Other suitable parameters are contemplated to suit the application.

As illustrated in FIG. 2A, the yields and losses may include phenyl and methyl losses, the energy efficiency may include net energy consumption, the operational limits may include speed limits or flow rates, and the process efficiency may include reactor conversion. Utility inputs and outputs, such as steam, gas, and electricity, and utility outputs, such as operational parameters and values, can also be displayed on the display device 20. It is preferred that the displayed parameters include time-based information in the form of miniature trends adjacent to associated parameter values. Similarly, FIGS. 2B-2E illustrate exemplary sublevels of the display items 32, featuring more detailed descriptions of the corresponding higher level display items. For example, FIG. 2B illustrates the detailed information about the phenyl loss 32 shown in FIG. 2A. Also, FIG. 2C illustrates the detailed information about the methyl loss 32 shown in FIG. 2A, while FIG. 2D illustrates the detailed information about the speed limit reformate splitter 32 shown in FIG. 2A, and FIG. 2E illustrates the detailed information about the reactor conversion 32 shown in FIG. 2A.

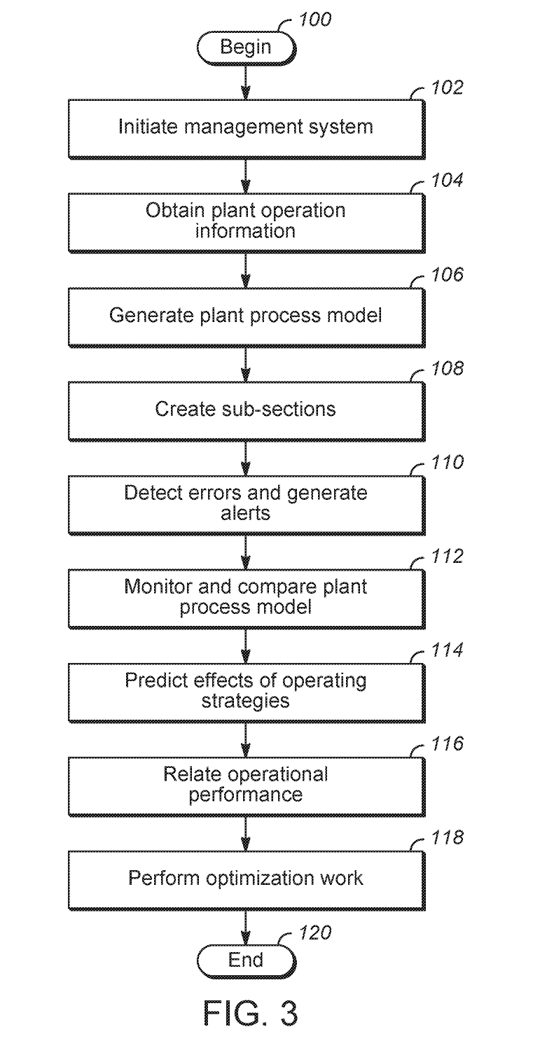

Referring now to FIG. 3, a simplified flow diagram is illustrated for an exemplary method of improving operation of a plant, such as the plant 12a-12n of FIGS. 1 and 2, according to one embodiment of this invention. Although the following steps are primarily described with respect to the embodiments of FIGS. 1 and 2, it should be understood that the steps within the method may be modified and executed in a different order or sequence without altering the principles of the present invention.

The method begins at step 100. In step 102, the management system 10 is initiated by a computer system that is remote from the plant 12a-12n. The method is desirably automatically performed by the computer system; however, the invention is not intended to be so limited. One or more steps can include manual operations or data inputs from the sensors and other related systems, as desired.

In step 104, the management system 10 obtains plant operation information or plant data from the plant 12a-12n over the network 16. The plant operation information or plant data preferably includes plant process condition data or plant process data, plant lab data and/or information about plant constraints. It is contemplated that the plant data includes at least one of: the plant lab data and the plant process condition data, and the plant constraint. As used herein, “plant lab data” refers to the results of periodic laboratory analyses of fluids taken from an operating process plant conducted by an operator of the plant. As used herein, “plant process data” refers to data measured by sensors in the process plant.

In step 106, a plant process model is generated using the plant operation information. The plant process model predicts plant performance that is expected based upon the plant operation information, i.e., how the plant 12a-12n is operated. The plant process model results can be used to monitor the health of the plant 12a-12n and to determine whether any upset or poor measurement occurred. The plant process model is desirably generated by an iterative process that models at various plant constraints to determine the desired plant process model.

In step 108, a process simulation unit is utilized to model the operation of the plant 12a-12n. Because the simulation for the entire unit would be quite large and complex to solve in a reasonable amount of time, each plant 12a-12n may be divided into smaller virtual sub-sections consisting of related unit operations. An exemplary process simulation unit 10, such as a UniSim® Design Suite, is disclosed in U.S. Patent Publication No. 2010/0262900 which is incorporated by reference in its entirety. It is contemplated that the process simulation unit 10 can be installed in the optimization unit 22.

For example, in one embodiment, a fractionation column and its related equipment such as its condenser, receiver, reboiler, feed exchangers, and pumps would make up a sub-section. All available plant data from the unit, including temperatures, pressures, flows, and laboratory data are included in the simulation as Distributed Control System (DCS) variables. Multiple sets of the plant data are compared against the process model and model fitting parameter and measurement offsets are calculated that generate the smallest errors.

In step 110, fit parameters or offsets that change by more than a predetermined threshold, and measurements that have more than a predetermined range of error may trigger further action. Large changes in offsets or fit parameters indicate the model tuning may be inadequate. Overall data quality for the set of data is flagged as questionable. Individual measurements with large errors may be eliminated from the fitting algorithm and an alert message or warning signal raised to have the measurement inspected and rectified.

In step 112, the management system 10 monitors and compares the plant process model with actual plant performance to ensure the accuracy of the plant process model. Typically, for process models to be effective, they must accurately reflect the actual operating capabilities of the commercial processes. This is achieved by calibrating models to reconciled data. Key operating variables, such as cut points and tray efficiencies, are adjusted to minimize differences between measured and predicted performance. In one embodiment of this invention, upon a predetermined difference between the plant process model and actual plant performance, the plant process model is updated, and the updated plant process model is used during the next cycle of the method. The updated plant process model is also desirably used to optimize the plant processes.

In step 114, the plant process model is used to accurately predict the effects of varying feedstocks and operating strategies. Consequently, regular updating or tuning of the plant process model according to the method of this invention using reconciled data enables the refiner to assess changes in process capability. A calibrated, rigorous model of this type can enable refinery operations engineers and planning personnel to identify process performance issues, so that they can be addressed before they have a serious impact on operating economics.

For example, calculations such as yields, product properties, and coke production rate can be key indicators of process problems when examined as trends over time. Regular observation of such trends can indicate abnormal declines in performance or mis-operations. For example, it is contemplated that if a rapid decline in C₅+ hydrocarbon yields in a naphtha reforming unit is observed, this may point to an increasing rate of coke production, which then can be traced back to an incorrect water-chloride balance in the reactor circuit or incorrect platforming feed pre-treatment. It is also contemplated that the plant process model can also support improvement studies that consider both short-term operational changes and long-term revamp modifications to generate improved economics on the unit.

In step 116, an output interface is designed to directly relate operational economic performance (e.g., cost of production per ton of product), which is the main concern of the plant management, to the primary operating variables of the plant (e.g., flow of steam to a heat exchanger or setpoint on a column composition controller). This is accomplished by relating the economic performance to the plant operation through a cascade of more detailed screens, each of which is designed to allow the user to quickly view which variables are causing the departure from the target economic performance.

In one embodiment, a top level screen displays key process effectiveness parameters (e.g., yield of desired product as a ratio of feed consumed), process efficiency (e.g., energy consumption per unit product), and process capacity (e.g., current operating capacity as a ratio of design or available capacity). Each parameter is displayed with an icon 34 that allows the user to quickly understand the parameter's condition (e.g., a red-yellow-green traffic light for assessing whether the parameter is out of range (red), nearly out of range (yellow), or within expected range (green)). Selecting a parameter automatically brings the user to a particular display with the next hierarchical level of parameters that are related to it. This continues until the user reaches the level of the measured value at the plant.

As an example only, the plant 12a-12n converts and separates an aromatic-hydrocarbon rich stream into high-valued product streams of benzene and paraxylene. The top level display includes overall process effectiveness parameters like desired product production per unit feed and conversion or retention of functional molecular groups (i.e. phenyl groups or methyl groups). In this example, a typical overall plant methyl loss would be 2%. If the actual methyl loss is greater than 2.2%, the parameter would be flagged with a red light.

Upon selecting the methyl loss parameter, the user is given a display of all the unit operations in the plant 12 that affect methyl loss and indicate which ones, if any, are out of range. Methyl loss is affected by fractionation unit operations (e.g., improper reflux-to-feed ratio and/or incorrect target operating temperature) and conversion unit operations (e.g., non-selective reactions). According to this example, the transalkylation reactor is the largest contributor to methyl loss and is what causes the overall methyl loss to be high (e.g., normally 1.08% and considered high if more than 1.25%).

When the user selects the transalkylation reactor, the user will be given a display of a level of further detail, which would indicate the health of the reactor that is converting it. This health includes the operating conditions, such as hydrogen-to-hydrocarbon ratio (typically 3.0), reactor pressure (typically ˜2.76 MPa (gauge) or ˜400 psi), and reactor inlet temperature (typically 375° C. or 707° F.). Ultimately, from the final display, the user understands which operating variable (e.g., reactor inlet temperature) needs to be adjusted to improve the overall plant operation. The display includes expert knowledge from pilot plant testing and operating experience in order to help establish the operating envelopes. For example, the reactor inlet temperature operating range for a typical transalkylation reactor is in the range of between 360° C. (or 680° F.) and 400° C. (or 752° F.).

A benefit of the method of this invention is its long-term sustainability. Often, projects to improve plant profitability achieve reasonable benefits for a modest duration, but these improvements decay over time. This decay is usually the result of inadequate time and expertise of available in-house technical personnel. Web-based optimization using the method of this invention helps operators bridge existing performance gaps and better leverage the expertise of their personnel in a way that can be sustained in the long term.

Some plant operators have attempted to use locally installed process models to address the optimization needs of a refinery. While several such process model offerings exist in the marketplace, these tools lose value over time as there are inadequate methods for keeping them tuned (e.g. modeling catalyst deactivation, temporary equipment limitations, and the like) and configured to take into account plant flow scheme and equipment modifications. Additionally, the cost associated with performing the model maintenance function can be relatively large and the expertise difficult to maintain or replace. In this configuration, over time, the investment made in acquiring such models does not deliver the intended value. The web-enabled platform specifically addresses these shortcomings by remotely hosting and maintaining the models.

Beyond the technical benefits, implementation of the web-based method of the present management system 10 delivers tangible benefits that address the customer's managerial challenges. Such a process aids in improving training and development of technical personnel, automation of business processes and development of operational excellence. Training of new engineers and operators is simplified as there is a central repository of knowledge about the individual process units. Furthermore, engineers can more easily be rotated among several process units to give them broader experience. This rotation can be done with the assurance that consistency of knowledge is transferred by highly repeatable remote performance monitoring processes and by professionals interacting with skilled technical services personnel.

Returning to FIG. 3, in step 118, a business optimization work process is made more predictable by providing a common platform for viewing results to the various stakeholders, such as planners, managers, engineers and technicians. For example, the management system 10 (FIGS. 1 and 2) is used to provide a simplified and robust look at process units at various locations, thereby allowing quick allocation of resources to process units that either have the highest feed processing opportunity or the most need for maintenance and upgrade.

Further advantage is achieved by utilizing a common infrastructure that clearly establishes links between the plant process and economic performance. As all process, analytical, and economic data are used to provide reports that are linked through process models, all operators can effectively communicate and make decisions from a common set of information, thereby driving the whole organization to focus on continuous economic performance maximization. The method ends at step 120.

### SPECIFIC EMBODIMENTS

While the following is described in conjunction with specific embodiments, it will be understood that this description is intended to illustrate and not limit the scope of the preceding description and the appended claims.

A first embodiment of the invention is a management system for improving operation of a plant, the management system comprising a server coupled to the management system for communicating with the plant via a communication network; a computer system having a web-based platform for receiving and sending plant data related to the operation of the plant over the network; a display device for interactively displaying the plant data; and an optimization unit configured for optimizing at least a portion of a refining or petrochemical process of the plant by acquiring the plant data from the plant on a recurring basis, analyzing the plant data for completeness, correcting the plant data for an error, wherein the optimization unit corrects the plant data for a measurement issue and an overall mass balance closure, and generates a set of reconciled plant data based on the corrected plant data. An embodiment of the invention is one, any or all of prior embodiments in this paragraph up through the first embodiment in this paragraph, further comprising an interface module configured for providing an interface between the management system, a database storing the plant data, and the network. An embodiment of the invention is one, any or all of prior embodiments in this paragraph up through the first embodiment in this paragraph, wherein the interface module receives the plant data from at least one plant sensor and at least one plant parameter via the network. An embodiment of the invention is one, any or all of prior embodiments in this paragraph up through the first embodiment in this paragraph, wherein the optimization unit is configured such that the corrected data is used as an input to a simulation process in which a process model is tuned to ensure that the simulation process matches the reconciled plant data. An embodiment of the invention is one, any or all of prior embodiments in this paragraph up through the first embodiment in this paragraph, wherein the optimization unit is configured such that an output of the reconciled plant data is inputted into a tuned flowsheet, and then is generated as a predicted data. An embodiment of the invention is one, any or all of prior embodiments in this paragraph up through the first embodiment in this paragraph, wherein each tuned flowsheet is a collection of virtual process model objects as a unit of process design. An embodiment of the invention is one, any or all of prior embodiments in this paragraph up through the first embodiment in this paragraph, wherein the optimization unit is configured such that a delta value being a difference between the reconciled data and the predicted data is validated to ensure that a viable optimization case is established for a simulation process run. An embodiment of the invention is one, any or all of prior embodiments in this paragraph up through the first embodiment in this paragraph, wherein a tuned simulation engine is used as a basis for the viable optimization case being run with the set of the reconciled data as an input, and an output from the tuned simulation engine is an optimized data. An embodiment of the invention is one, any or all of prior embodiments in this paragraph up through the first embodiment in this paragraph, wherein a difference between the reconciled data and the optimized data indicates one or more plant variables which are capable of being changed to reach a greater performance for the plant. An embodiment of the invention is one, any or all of prior embodiments in this paragraph up through the first embodiment in this paragraph, wherein the optimization unit defines an objective function as a user-defined calculation of total cost of operation during the operation of the plant. An embodiment of the invention is one, any or all of prior embodiments in this paragraph up through the first embodiment in this paragraph, further comprising an analysis unit configured for determining an operating status of the plant. An embodiment of the invention is one, any or all of prior embodiments in this paragraph up through the first embodiment in this paragraph, wherein the analysis unit determines the operating status of the plant based on at least one of a kinetic model, a parametric model, an analytical tool, and a related knowledge and best practice standard. An embodiment of the invention is one, any or all of prior embodiments in this paragraph up through the first embodiment in this paragraph, wherein the analysis unit receives historical or current performance data of the plant to proactively predict future actions to be performed. An embodiment of the invention is one, any or all of prior embodiments in this paragraph up through the first embodiment in this paragraph, wherein the analysis unit determines a target operational parameter of a final product based on at least one of an actual current parameter and a historical operational parameter. An embodiment of the invention is one, any or all of prior embodiments in this paragraph up through the first embodiment in this paragraph, wherein the analysis unit establishes a boundary or threshold of an operating parameter of the plant based on at least one of an existing limit and an operation condition. An embodiment of the invention is one, any or all of prior embodiments in this paragraph up through the first embodiment in this paragraph, wherein the analysis unit establishes a relationship between at least two operational parameters related to a specific process for the operation of the plant. An embodiment of the invention is one, any or all of prior embodiments in this paragraph up through the first embodiment in this paragraph, further comprising a visualization unit configured for displaying plant performance variables using the display device. An embodiment of the invention is one, any or all of prior embodiments in this paragraph up through the first embodiment in this paragraph, wherein the visualization unit displays a current state of the plant using a dashboard, grouping related data into one or more display sets based on a source of the plant data for illustrating a relationship of the displayed data. An embodiment of the invention is one, any or all of prior embodiments in this paragraph up through the first embodiment in this paragraph, wherein the visualization unit provides and controls a visual interface between the management system and an operator using a human machine interface. An embodiment of the invention is one, any or all of prior embodiments in this paragraph up through the first embodiment in this paragraph, wherein the visualization unit is configured for receiving an input signal via the human machine interface from at least one of the operator and the management system.

A second embodiment of the invention is a management system for improving operation of a plant, the management system comprising a server coupled to the management system for communicating with the plant via a communication network; a computer system having a web-based platform for receiving and sending plant data related to the operation of the plant over the network; a display device for interactively displaying the plant data, wherein the display device is configured for graphically or textually receiving an input signal from the management system using a human machine interface via a dedicated communication infrastructure; and a visualization unit configured for creating an interactive display for a user, and displaying the plant data using a visual indicator on the display device based on a hue and color technique which discriminates a quality of the displayed plant data. An embodiment of the invention is one, any or all of prior embodiments in this paragraph up through the second embodiment in this paragraph, wherein the visualization unit provides a hierarchical structure of detailed explanation on the plant data shown on the display device. An embodiment of the invention is one, any or all of prior embodiments in this paragraph up through the second embodiment in this paragraph, wherein the hierarchical structure is selectively expanded or drilled down into a particular level of the plant data. An embodiment of the invention is one, any or all of prior embodiments in this paragraph up through the second embodiment in this paragraph, wherein the visualization unit provides a drill down navigation when selectively clicking on a display item on the display device for opening up a new display window having more detailed information about the plant data than an initial screen. An embodiment of the invention is one, any or all of prior embodiments in this paragraph up through the second embodiment in this paragraph, wherein the visualization unit displays the plant data related to an aromatics complex. An embodiment of the invention is one, any or all of prior embodiments in this paragraph up through the second embodiment in this paragraph, wherein the visualization unit displays a high-level process effectiveness calculation and energy efficiency parameter of the plant with a corresponding operating limit. An embodiment of the invention is one, any or all of prior embodiments in this paragraph up through the second embodiment in this paragraph, wherein the visualization unit displays a utility input and a utility output related to the operation of the plant on the display device. An embodiment of the invention is one, any or all of prior embodiments in this paragraph up through the second embodiment in this paragraph, wherein the plant data includes time-based information in a form of a trend disposed adjacent to an associated parameter value. An embodiment of the invention is one, any or all of prior embodiments in this paragraph up through the second embodiment in this paragraph, wherein the visualization unit displays at least one sublevel of a display item on the display device featuring a more detailed description of the corresponding higher level display item. An embodiment of the invention is one, any or all of prior embodiments in this paragraph up through the second embodiment in this paragraph, wherein the visual indicator includes an icon 34 having a red-yellow-green traffic light configuration for indicating whether the plant data is out of range, nearly out of range, or within expected range using the hue and color technique.

A third embodiment of the invention is a method for improving operation of a plant, the management method comprising providing a server coupled to a management system for communicating with the plant via a communication network; providing a computer system having a web-based platform for receiving and sending plant data related to the operation of the plant over the network; providing a display device for interactively displaying the plant data, the display device being configured for graphically or textually receiving an input signal from the management system using a human machine interface via a dedicated communication infrastructure; creating an interactive display for a user, and displaying the plant data using a visual indicator on the display device based on a hue and color technique, which discriminates a quality of the displayed plant data; and generating a plant process model using the plant data for predicting plant performance expected based on the plant data, the plant process model being generated by an iterative process that models based on at least one plant constraint being monitored for the operation of the plant. An embodiment of the invention is one, any or all of prior embodiments in this paragraph up through the third embodiment in this paragraph, further comprising dividing the operation of the plant into a plurality of virtual sub-sections, each sub-section having a unit operation. An embodiment of the invention is one, any or all of prior embodiments in this paragraph up through the third embodiment in this paragraph, further comprising comparing the plant data with the plant process model and a fit parameter for calculating a measurement offset. An embodiment of the invention is one, any or all of prior embodiments in this paragraph up through the third embodiment in this paragraph, further comprising detecting a change in a fit parameter by more than a predetermined threshold. An embodiment of the invention is one, any or all of prior embodiments in this paragraph up through the third embodiment in this paragraph, further comprising detecting a change in a measurement offset that has more than a predetermined range of error. An embodiment of the invention is one, any or all of prior embodiments in this paragraph up through the third embodiment in this paragraph, further comprising generating an alert message or warning based on a change in at least one of a fit parameter and a measurement offset. An embodiment of the invention is one, any or all of prior embodiments in this paragraph up through the third embodiment in this paragraph, further comprising monitoring and comparing the plant process model with actual plant performance to ensure an accuracy of the plant process model. An embodiment of the invention is one, any or all of prior embodiments in this paragraph up through the third embodiment in this paragraph, further comprising calibrating the plant process model based on a reconciled data by adjusting the plant data to minimize a difference between measured and predicted performance of the plant. An embodiment of the invention is one, any or all of prior embodiments in this paragraph up through the third embodiment in this paragraph, further comprising predicting an effect of the plant process model by regularly updating or tuning the plant process model using the reconciled data. An embodiment of the invention is one, any or all of prior embodiments in this paragraph up through the third embodiment in this paragraph, further comprising updating the plant process model based on a predetermined difference between the plant process model and actual plant performance. An embodiment of the invention is one, any or all of prior embodiments in this paragraph up through the third embodiment in this paragraph, further comprising using the updated plant process model during a next cycle of the operation of the plant. An embodiment of the invention is one, any or all of prior embodiments in this paragraph up through the third embodiment in this paragraph, further comprising detecting a fault of the operation of the plant based on a trend of a key indicator during a predetermined time period. An embodiment of the invention is one, any or all of prior embodiments in this paragraph up through the third embodiment in this paragraph, further comprising relating operational economic performance of the plant to a primary operating variable of the plant to be displayed on the display device. An embodiment of the invention is one, any or all of prior embodiments in this paragraph up through the third embodiment in this paragraph, further comprising performing an optimization process by providing a common set of information linking between the plant process model and operation performance of the plant.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

While a particular embodiment of the present management system has been described herein, it will be appreciated by those skilled in the art that changes and modifications may be made thereto without departing from the invention in its broader aspects and as set forth in the following claims.

What is claimed is:

1. A management system for improving operation of a plant, the management system comprising:
a server coupled to the management system for communicating with the plant via a communication network;
a computer system having a web-based platform for receiving and sending plant data related to the operation of the plant over the network;
a display device for interactively displaying the plant data; and
an optimization unit configured for optimizing at least a portion of a refining or petrochemical process of the plant by acquiring the plant data from the plant on a recurring basis, analyzing the plant data for completeness, correcting the plant data for an error,
wherein the optimization unit corrects the plant data for a measurement issue and an overall mass balance closure, and generates a set of reconciled plant data based on the corrected plant data.

2. The management system of claim 1, further comprising an interface module configured for providing an interface between the management system, a database storing the plant data, and the network.

3. The management system of claim 2, wherein the interface module receives the plant data from at least one plant sensor and at least one plant parameter via the network.

4. The management system of claim 1, wherein the optimization unit is configured such that the corrected data is used as an input to a simulation process in which a process model is tuned to ensure that the simulation process matches the reconciled plant data.

5. The management system of claim 1, wherein the optimization unit is configured such that an output of the reconciled plant data is inputted into a tuned flowsheet, and then is generated as a predicted data.

6. The management system of claim 5, wherein each tuned flowsheet is a collection of virtual process model objects as a unit of process design.

7. The management system of claim 5, wherein the optimization unit is configured such that a delta value being a difference between the reconciled data and the predicted data is validated to ensure that a viable optimization case is established for a simulation process run.

8. The management system of claim 7, wherein a tuned simulation engine is used as a basis for the viable optimization case being run with the set of the reconciled data as an input, and an output from the tuned simulation engine is an optimized data.

9. The management system of claim 8, wherein a difference between the reconciled data and the optimized data indicates one or more plant variables which are capable of being changed to reach a greater performance for the plant.

10. The management system of claim 1, wherein the optimization unit defines an objective function as a user-defined calculation of total cost of operation during the operation of the plant.

11. The management system of claim 1, further comprising an analysis unit configured for determining an operating status of the plant.

12. The management system of claim 11, wherein the analysis unit determines the operating status of the plant based on at least one of: a kinetic model, a parametric model, an analytical tool, and a related knowledge and best practice standard.

13. The management system of claim 11, wherein the analysis unit receives historical or current performance data of the plant to proactively predict future actions to be performed.

14. The management system of claim 11, wherein the analysis unit determines a target operational parameter of a final product based on at least one of: an actual current parameter and a historical operational parameter.

15. The management system of claim 11, wherein the analysis unit establishes a boundary or threshold of an operating parameter of the plant based on at least one of: an existing limit and an operation condition.

16. The management system of claim 11, wherein the analysis unit establishes a relationship between at least two operational parameters related to a specific process for the operation of the plant.

17. The management system of claim 1, further comprising a visualization unit configured for displaying plant performance variables using the display device.

18. The management system of claim 17, wherein the visualization unit displays a current state of the plant using a dashboard, grouping related data into one or more display sets based on a source of the plant data for illustrating a relationship of the displayed data.

19. The management system of claim 17, wherein the visualization unit provides and controls a visual interface between the management system and an operator using a human machine interface.

20. The management system of claim 19, wherein the visualization unit is configured for receiving an input signal via the human machine interface from at least one of: the operator and the management system.

21. A management system for improving operation of a plant, the management system comprising:
a server coupled to the management system for communicating with the plant via a communication network;
a computer system having a web-based platform for receiving and sending plant data related to the operation of the plant over the network;
a display device for interactively displaying the plant data,
wherein the display device is configured for graphically or textually receiving an input signal from the management system using a human machine interface via a dedicated communication infrastructure; and
a visualization unit configured for creating an interactive display for a user, and displaying the plant data using a visual indicator on the display device based on a hue and color technique which discriminates a quality of the displayed plant data.

22. The management system of claim 21, wherein the visualization unit provides a hierarchical structure of detailed explanation on the plant data shown on the display device.

23. The management system of claim 22, wherein the hierarchical structure is selectively expanded or drilled down into a particular level of the plant data.

24. The management system of claim 21, wherein the visualization unit provides a drill down navigation when selectively clicking on a display item on the display device for opening up a new display window having more detailed information about the plant data than an initial screen.

25. The management system of claim 21, wherein the visualization unit displays the plant data related to an aromatics complex.

26. The management system of claim 21, wherein the visualization unit displays a high-level process effectiveness calculation and energy efficiency parameter of the plant with a corresponding operating limit.

27. The management system of claim 21, wherein the visualization unit displays a utility input and a utility output related to the operation of the plant on the display device.

28. The management system of claim 21, wherein the plant data includes time-based information in a form of a trend disposed adjacent to an associated parameter value.

29. The management system of claim 21, wherein the visualization unit displays at least one sublevel of a display item on the display device featuring a more detailed description of the corresponding higher level display item.

30. The management system of claim 21, wherein the visual indicator includes an icon having a red-yellow-green traffic light configuration for indicating whether the plant data is out of range, nearly out of range, or within expected range using the hue and color technique.

31. A management method for improving operation of a plant, the management method comprising:
providing a server coupled to a management system for communicating with the plant via a communication network;
providing a computer system having a web-based platform for receiving and sending plant data related to the operation of the plant over the network;
providing a display device for interactively displaying the plant data, the display device being configured for graphically or textually receiving an input signal from the management system using a human machine interface via a dedicated communication infrastructure;
creating an interactive display for a user, and displaying the plant data using a visual indicator on the display device based on a hue and color technique, which discriminates a quality of the displayed plant data; and
generating a plant process model using the plant data for predicting plant performance expected based on the plant data, the plant process model being generated by an iterative process that models based on at least one plant constraint being monitored for the operation of the plant.

32. The management method of claim 31, further comprising dividing the operation of the plant into a plurality of virtual sub-sections, each sub-section having a unit operation.

33. The management method of claim 31, further comprising comparing the plant data with the plant process model and a fit parameter for calculating a measurement offset.

34. The management method of claim 31, further comprising detecting a change in a fit parameter by more than a predetermined threshold.

35. The management method of claim 31, further comprising detecting a change in a measurement offset that has more than a predetermined range of error.

36. The management method of claim 31, further comprising generating an alert message or warning based on a change in at least one of: a fit parameter and a measurement offset.

37. The management method of claim 31, further comprising monitoring and comparing the plant process model with actual plant performance to ensure an accuracy of the plant process model.

38. The management method of claim 31, further comprising calibrating the plant process model based on a reconciled data by adjusting the plant data to minimize a difference between measured and predicted performance of the plant.

39. The management method of claim 38, further comprising predicting an effect of the plant process model by regularly updating or tuning the plant process model using the reconciled data.

40. The management method of claim 31, further comprising updating the plant process model based on a predetermined difference between the plant process model and actual plant performance.

41. The management method of claim 40, further comprising using the updated plant process model during a next cycle of the operation of the plant.

42. The management method of claim 31, further comprising detecting a fault of the operation of the plant based on a trend of a key indicator during a predetermined time period.

43. The management method of claim 31, further comprising relating operational economic performance of the plant to a primary operating variable of the plant to be displayed on the display device.

44. The management method of claim 31, further comprising performing an optimization process by providing a common set of information linking between the plant process model and operational performance of the plant.

45. The management system of claim 1, wherein the display device interactively displays the plant data in real time.
